(19) United States
(12) Patent Application Publication
(10) Pub. No.: US 2009/0146561 A1
(43) Pub. Date: Jun. 11, 2009

(54) SOLID STATE ILLUMINATION DEVICE

(75) Inventor: WEN-JANG JIANG, Chu-Nan (TW)

Correspondence Address: PCE INDUSTRY, INC.;ATT. Steven Reiss, 458 E. LAMBERT ROAD, FULLERTON, CA, 92835, US

(73) Assignee: FOXSEMICON INTEGRATED TECHNOLOGY, INC., Chu-Nan (TW)

(21) Appl. No.: 12/019,925

(22) Filed: Jan. 25, 2008

(30) Foreign Application Priority Data
Dec. 11, 2007 (CN) 200710202989.4

(51) Int. Cl. H01J 1/62

(52) U.S. Cl. 313/512

(57) ABSTRACT

A solid state illumination device (10) includes a LED (12) and a mounting base (16). The LED includes a housing (124), two LED chips (126, 127), and two electrodes (128, 129). The electrodes have first ends (128a, 129a) electrically connected with the LED chips and capsulated in the housing with the LED chips, and second ends (128b, 129b) exposed outside the housing. The mounting base includes a main body (162) with a receptacle defined therein, a resilient ring (163), two receiving holes (164), and two power supply electrodes (166) arranged in the receiving holes, respectively. The second ends of the electrodes are received in the receiving holes of the mounting base and electrically connect with the power supply electrodes. The resilient ring surrounds the main body and exerts a radial force to the housing to mount the LED to the mounting base.

### BACKGROUND

1. Technical Field

The present invention generally relates to solid state illumination devices and more particular to illumination devices using solid state light emitting diodes (LEDs).

2. Description of Related Art

Solid state LEDs are widely used in daily life, such as in illumination devices or non-emissive display devices, due to their high brightness, long life-span, and wide color gamut.

Minimum illumination devices such as Christmas lamps, or rainbow lamps typically include a mounting base and a solid state LED having electrodes inserted into receiving holes of the mounting base. The solid state LED is maintained to the mounting base by friction between the electrodes of the solid state LED and peripheral surfaces of the receiving holes of the mounting base. However, the friction is not adequate to keep the solid state LED secured in the mounting base when the LED is pulled with sufficient force. Therefore, there is a need to provide an improved illumination device.

### SUMMARY

A solid state illumination device is provided. The solid state illumination device includes a solid state LED and a mounting base. The solid state LED includes a housing, a solid state LED chip, and a plurality of electrodes. The electrodes have first ends electrically connected with the solid state LED chip and located in the housing with the solid state LED chip, and second ends exposed outside the housing. The mounting base includes a main body with a receptacle defined therein, a resilient resilient ring, a plurality of receiving holes, and a plurality of power supply electrodes arranged in the receiving holes respectively. The second ends of the electrodes are received in the receiving holes of the mounting base and electrically connect with the power supply electrodes. The resilient resilient ring surrounds and exerts a radial force to the housing to mount the LED to the mounting base.

Other advantages and novel features of the present solid state illumination device will become more apparent from the following detailed description of preferred embodiments when taken in conjunction with the accompanying drawings, in which:

### BRIEF DESCRIPTION OF THE DRAWINGS

FIG. 1 is an exploded, cross sectional view of a solid state illumination device according to a first embodiment of the present invention;

FIG. 2 is an assembled view of the solid state illumination device of FIG. 1; and

FIG. 3 is an exploded, cross sectional view of a solid state illumination device according to a second embodiment of the present invention.

### DETAILED DESCRIPTION

Reference will now be made to the drawing figures to describe the preferred embodiment in detail.

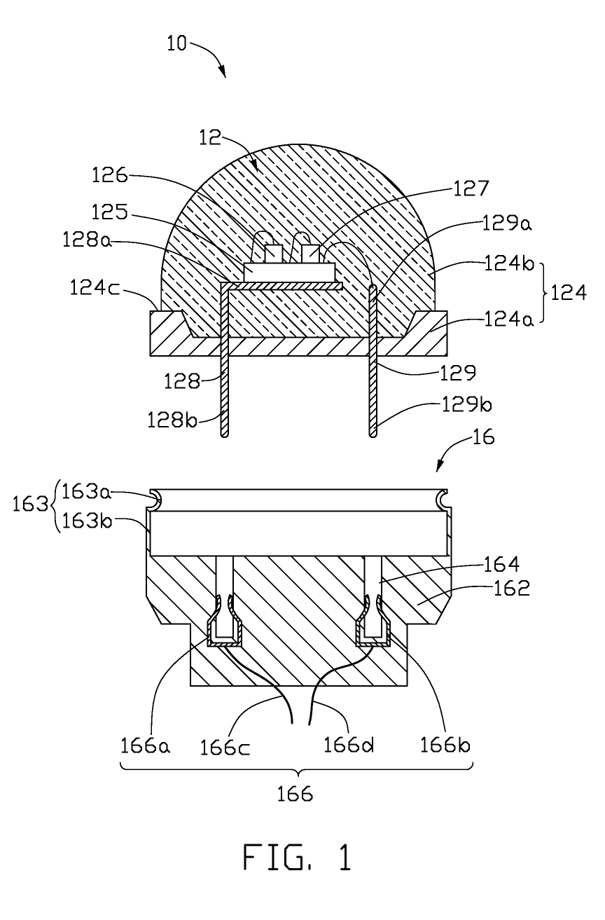

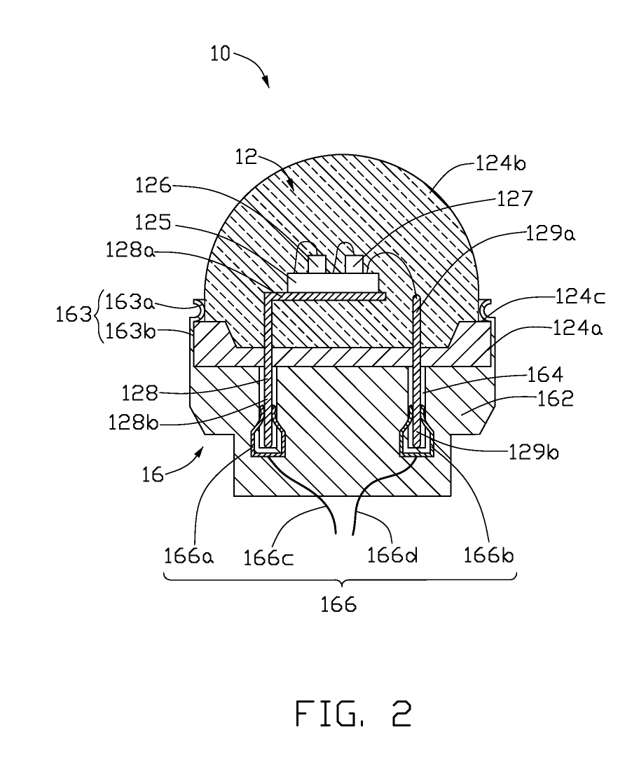

Referring to FIGS. 1 and 2, a solid state illumination device 10 according to a first embodiment of the present invention is shown. The solid state illumination device 10 includes a solid state light emitting diode such as an inorganic light emitting diode (LED), or an organic light emitting diode (OLED), and a mounting base 16 for mounting the solid state light emitting diode. In this embodiment, the solid state light emitting diode is an LED 12.

The LED 12 includes a housing 124, a circuit carrier 125, two LED chips 126, 127, a first electrode and a second electrode 128, 129. The circuit carrier 125, the LED chips 126, 127, and top portions of the first and the second electrodes 128, 129 are located in the housing 124.

The housing 124 includes a substrate 124a and a transparent cover 124b fixed on the substrate 124a. The substrate 124a is made of plastic or ceramic, and the cover 124b is selected from a group comprising of epoxy resin and silicone. The substrate 124a includes an annular flange 124c radially extending beyond an outer surface of a bottom end of the cover 124b.

The first and the second electrodes 128, 129 are made of conductive materials such as copper, iron, or metal alloys. The first electrode 128 is substantially L-shaped in profile and includes a top end 128a and a bottom end 128b. The circuit carrier 125 is mounted on the top end 128a of the first electrode 128, and the LED chips 126, 127 are located on the circuit carrier 125. A plurality of circuits (not shown) is disposed on the circuit carrier 125, electrically connecting the first electrode 128 with the LED chips 126, 127. The second electrode 129 is substantially linear in profile and includes a top end 129a and a bottom end 129b. The top end 129a of the second electrode 129 electrically connects with the LED chips 126, 127 and the top end 128a of the first electrode 128. The top ends 128a, 129a of the first and the second electrodes 128, 129 are received in the cover 124b of the housing 124, and the bottom ends 128b, 129b of the first and the second electrodes 128, 129 extend through the substrate 124a and are exposed outside the substrate 124a of the housing 124.

The mounting base 16 includes a main body 162 with a receptacle defined therein, a resilient ring 163, two receiving holes 164, and two power supply electrodes 166.

The resilient ring 163 is a resilient ring-shaped tube disposed around a top portion of the main body 162 of the mounting base 16. The resilient ring 163 is made of resilient materials such as plastic, or rubber, and extends upwardly from a topmost edge of the main body 162 and is integrally formed with the main body 162 of the mounting base 16 from a single piece. A top end of an outer surface of the resilient ring 163 indents inwardly and an annular protrusion 163a is therefore formed on a top end of an inner surface of the resilient ring 163. A minimum inner diameter of the annular protrusion 163a is less than a diameter of a bottom portion of the cover 124b of the housing 124. The bottom portion of the cover 124b intimately contacts with the annular protrusion 163a of the resilient ring 163 when the LED 12 is mounted to the mounting base 16. A recess 163b is formed on a bottom end of the inner surface of the resilient ring 163 below the annular protrusion 163a.

The receiving holes 164 are defined in the main body 162 of the mounting base 16 for receiving the bottom ends 128b, 129b of the first and the second electrodes 128, 129.

The power supply electrodes 166 include two claspers 166a, 166b and two wires 166c, 166d electrically connecting the claspers 166a, 166b of the power supply electrodes 166 with an external power supply (not shown). The claspers 166a, 166b are embedded in the main body 162 of the mounting base 16 with top ends thereof extending into the receiving holes 164 of the mounting base 16. Alternatively, the claspers 166a, 166b may not be embedded in the main body 162 of the mounting base 16 and be directly positioned into the receiving holes 164 of the mounting base 16. The bottom ends 128b, 129b of the first and the second electrodes 128, 129 extend into the receiving holes 164 of the mounting base 16 and are clasped by the claspers 166a, 166b of the power supply electrodes 166.

In assembly of the solid state illumination device 10, the LED 12 is positioned on the resilient ring 163 of the mounting base 16 with bottom portions of the bottom ends 128b, 129b of the first and the second electrodes 128, 129 respectively extending into top portions of the receiving holes 164 of the mounting base 16. The LED 12 is pressed downwardly and slides toward the mounting base 16 until the annular flange 124c of the LED 12 is received in the recess 163b of the resilient ring 163 of the mounting base 16. When the annular flange 124c of the LED 12 is received in the recess 163b of the resilient ring 163 of the mounting base 16, the LED chips 126, 127 are located above a topmost end of the resilient ring 163 of the mounting base 16, preventing light emitted from the LED 12 being blocked by the resilient ring 163.

During the LED 12 slides toward the mounting base 16, the annular protrusion 163a of the resilient ring 163 is pressed to distort outwardly when the annular flange 124c of the LED 12 abuts against the annular protrusion 163a of the mounting base 16. When the annular flange 124c of the LED 12 slides below the annular protrusion 163a of the resilient ring 163 and is received in the recess 163b of the mounting base 16, the annular protrusion 163a of the resilient ring 163 is urged to distort inwardly under a radial resilient force and exerts a radial pressure on the bottom portion of the cover 124b of the housing 124, preventing the LED 12 from falling off from the mounting base 16. Meanwhile, a bottom surface of the annular protrusion 163a of the resilient ring 163 abuts against a top surface of the annular flange 124c of the LED 12, preventing the LED 12 from falling off from the mounting base 16. The bottom ends 128b, 129b of the first and the second electrodes 128, 129 are clasped by the claspers 166a, 166b of the power supply electrodes 166. Friction generated between outer surfaces of the bottom ends 128b, 129b of the first and the second electrodes 128, 129 and the claspers 166a, 166b of the power supply electrodes 166, further prevents the LED 12 from falling off from the mounting base 16. Therefore, the LED 12 is fixedly mounted to the mounting base 16.

Moreover, the radial pressure exerted on the bottom portion of the cover 124b of the housing 124 induces the annular protrusion 163a of the resilient ring 163 to intimately contact with an outer surface of the bottom portion of the cover 124b of the housing 124, thereby preventing moisture from entering into the mounting base 16 and damaging the first and the second electrodes 128, 129.

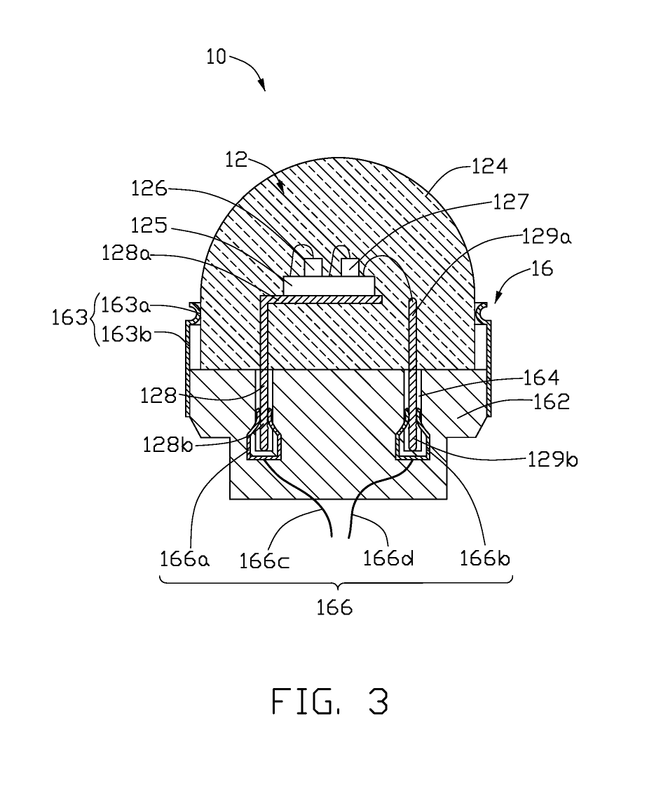

In the present solid state illumination device 10, the resilient ring 163 is integrally formed with the main body 162 of the mounting base 16 from a single piece. Alternatively, referring to FIG. 3, the resilient ring 163 can be a separate element, which is mounted to an outer surface of the top portion of the main body 162 of the mounting base 16.

In the present solid state illumination device 10, the outer surfaces of the bottom ends 128b, 129b of the first and the second electrodes 128, 129 are smooth surfaces. Alternatively, the outer surfaces of the bottom ends 128b, 129b of the first and the second electrodes 128, 129 may be rough surfaces having wave-shaped bulges (shown in FIG. 3), or serrated bulges, so as to increase friction between the outer surfaces of the bottom ends 128b, 129b of the first and the second electrodes 128, 129 and the claspers 166a, 166b of the power supply electrodes 166, thereby strengthening engagement between the LED 12 and the mounting base 16.

In the present solid state illumination device 10, the housing 124 includes the substrate 124a and the cover 124b. Alternatively, referring to FIG. 3, the substrate 124a of the housing 124 can be omitted and the housing 124 may merely include the cover 124b. Furthermore, referring to FIG. 3, the annular flange 124c of the housing 124 can be omitted which induces the LED 12 to be mounted to the mounting base 16 via the radial pressure generated between the annular protrusion 163a and the cover 124b and via the frictions generated between the bottom ends 128b, 129b of the first and the second electrodes 128, 129 and the claspers 166a, 166b of the power supply electrodes 166.

In the present solid state illumination device 10, the annular protrusion 163a is formed on the top end of the inner surface of the resilient ring 163. Alternatively, the annular protrusion 163a may be formed on a middle portion or a bottom end of the inner surface of the resilient ring 163. Alternatively, the annular protrusion 163a can be instead by a plurality of bulge points distributed around the inner surface of the resilient ring 163. When the bottom ends 128b, 129b of the first and the second electrodes 128, 129 of the LED 12 are inserted into the receiving holes 164 of the mounting base 16, the bulge points exert radial pressure on the cover 124b of the housing 124 to maintain the LED 12 to the mounting base 16.

It is to be understood, how ever, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A solid state illumination device comprising:
a solid state light emitting diode comprising a housing, a solid state light emitting diode chip, and a plurality of electrodes, the electrodes having first ends electrically connecting with the solid state light emitting diode chip, the solid state light emitting diode chip and the first ends of the electrodes being capsulated in the housing solid state light emitting diode chip, the electrodes having opposite second ends exposed outside the housing; and
a mounting base comprising a main body with a receptacle defined therein, a resilient ring, a plurality of receiving holes, and a plurality of power supply electrodes arranged in the receiving holes, respectively, the second ends of the electrodes being received in the receiving holes of the mounting base and electrically connecting with the power supply electrodes, the resilient ring surrounding and exerting a radial force to the housing to mount the solid state light emitting diode to the mounting base.

2. The solid state illumination device of claim 1, wherein the resilient ring comprises an annular protrusion extending inwardly toward an inner space of the resilient ring, a minimum inner diameter of the annular protrusion being less than a diameter of a corresponding portion of the housing.

3. The solid state illumination device of claim 2, wherein the resilient ring comprises a recess locating below the annular protrusion, the solid state light emitting diode comprising an annular flange being received in the recess of the resilient ring.

4. The solid state illumination device of claim 2, wherein the power supply electrodes each comprising a clasper and a wire electrically connected with the clasper, the clasper being embedded in the main body of the mounting base with top ends thereof extending into the receiving hole of the mounting base.

5. The solid state illumination device of claim 1, wherein the second end of the electrode is linear in profile.

6. The solid state illumination device of claim 5, wherein an outer surface of the second end of the electrode is a smooth surface.

7. The solid state illumination device of claim 5, wherein an outer surface of the second end of the electrode is a rough surface having wave shaped bulges.

8. The solid state illumination device of claim 1, wherein the annular protrusion of the resilient ring intimately contacts with an outer surface of the housing.
